(19) United States
(12) Patent Application Publication
(10) Pub. No.: US 2008/0089981 A1
(43) Pub. Date: Apr. 17, 2008

(54) Ketogenic diet

(75) Inventors: Raelene Butler, Liverpool (GB); Robert Johan Joseph Hageman, Wageningen (NL)

Correspondence Address: FOLEY AND LARDNER LLP;SUITE 500, 3000 K STREET NW, WASHINGTON, DC, 20007, US

(73) Assignee: N.V. Nutricia

(21) Appl. No.: 11/581,749

(22) Filed: Oct. 17, 2006

(51) Int. Cl. A23L 1/30

(52) U.S. Cl. 426/72

(57) ABSTRACT

The invention concerns a solid or semi-solid nutritional composition comprising proteins, lipids and digestible carbohydrates from at least two different sources, which provides 2520-3080 kilojoule per 100 g dry mass. The weight amounts of lipid to the sum of proteins and digestible carbohydrates is 2.6-3.8 to 1. The composition can be dissolved in water to provide a liquid food. The composition is especially useful for use as a nutritional formula for epileptic infants.

### FIELD OF THE INVENTION

The invention is related to a single palatable product that can be used as ketogenic diet, that is suitable for enteral use by epileptic patients from birth to 12 months of age, and that comprises low amounts of trans fatty acids, a high energy density and a relatively high amount of protein.

### BACKGROUND

The human body derives the energy that is needed predominantly from eating and metabolizing proteins, lipids and digestible carbohydrates. In the typical Western diet, digestible carbohydrates provide most of the energy, in most cases more than 50 energy percent, using 4 kcal or 16.8 kJ per gram as the conversion factor for digestible carbohydrates and proteins and 9 kcal or 37.8 kJ per gram for lipids. Metabolism of digestible carbohydrates predominantly releases glucose, which is a preferred energy source for the human body. Under special conditions most human cells can also use other organic compounds as energy source, such as amino acids, fatty acids and ketones. It is generally considered that increasing the amount of carbohydrates relative to that of lipids decreases the ketogenic properties of the product. Therefore classical ketogenic products for paediatric epileptics provide 4 times more lipids than the sum of proteins and digestible carbohydrates calculated on a weight base.

A ketogenic diet is a diet, which provides, after consumption, digestion and metabolism, ketones as a major energy source. These ketonic compounds include in particular aceto acetate, D-3 hydroxy butyrate and acetone. Keto-acids like oxaloacetate are not calculated as ketobodies. In particular a ketogenic diet comprises more than 60 g lipids per 100 g dry mass of the dietetic products, so more than 77 energy percent.

Ketogenic diets have been used for treatment of epileptic convulsions, and in treatments of obesity and weight management. Such diets may be composed of a variety of different meals which each fit within the diet, or may consist of one single product, which can be used for complete nourishment of a human being, when used as the sole nutrition. A product called Ketocal belongs to the latter category and is used for combating epilepsy, in particular intractable epilepsy in young infants. The product provides per 100 g dry matter 3011 kilojoules and comprises per 100 g dm 15.25 g protein, 73 g lipids and 3 g digestible carbohydrates. The amount of saturated fatty acids is about 22 wt % of the triglycerides. However, the extremely low amount of carbo-hydrates and the nature of the lipid made the product not optimal for human consumption. It is therefore an object of the current invention to provide a highly effective product that is better palatable, while providing a better lipid fraction in terms of ketogenic properties, tolerance, safety and a lower amount of trans fatty acids.

EP 0843972 discloses a complete product for enteral feeding persons suffering from the metabolic syndrome or hypertriglyceridaemia, which comprises 33-63 energy percent fats, and the proteins 5-30 en % of the composition and in which the fatty acids comprise 55-90 wt % medium chain fatty acids, 5-25 wt % polyunsaturated fatty acids and 0-30 wt % other fatty acids. The levels of palmitic acid are very low, in the order of 0.5-1% on fatty acid basis.

The invention provides a nutritional formula, which is suitable for use as complete nutrition when administered as dry, semi-solid or as a reconstituted liquid product, and which is especially intended for meeting the needs of epileptic infants, providing high levels of ketogenic components, while avoiding the drawbacks of the prior art products.

### DESCRIPTION OF THE INVENTION

The aforementioned problems of the prior art compositions have been addressed, in part, according to the invention by increasing the amount of digestible carbohydrates and selecting particular lipids as ingredients. These lipids not only provide the right type of energy when catabolized, but also provide relatively high amounts of palmitic acids, which can be used for biosynthetic purposes, in particular in pediatric epileptics, who typically suffer from growth retardation.

The product according to the invention is suitable for complete nourishment of human beings, in particular infants and more in particular pediatric epileptic patients. The product comprises a protein fraction, a lipid fraction, a fraction of digestible carbohydrates, and optionally, a vitamin fraction, a mineral/trace element fraction or other components.

The protein fraction comprises preferably peptides larger than 8 amino acids, which can make the product unsuitable for parenteral administration, due to potential allergic reactions. It is preferred to select proteins, which have strong emulgating properties, such as certain caseins. When partially hydrolyzed proteins are used, it is preferred to include at least 20% hydrolyzed whey as indicated below, in order to meet nutritional requirements. However, products usable for reconstitution in water or liquid formula should preferably contain lysolecithin, tartaric esters or combinations thereof as stabilization system in order to obtain a product that is suitable for drinking.

The product is preferably solid or semi-solid, such as a powder, bar, pudding, etcetera. A semi-solid product is understood to be a product having a solid content of more than 40 g per 100 g ready to use product. More preferably the semi-solids are supplied as powder, which can be reconstituted in water to be used as a single, complete food. The powder may comprise of primary particles, agglomerated primary particles or mixtures of particles of various size. Such powders can be manufactured using methods known in the art, such as spray drying. Spray drying is preferred when aids are used to improve flowing characteristics.

Useful liquids for feeding pediatric epileptic patients have an energy density of 0.9-3.0 kcal/ml (3.8-12.6 kJ/ml) preferably 1.1-2.0 kcal/ml (4.6-8.4 kJ) and more preferably 1.2-1.7 (5.0-7.2 kJ/ml). An energy density of 1.3-1.6 kcal/ml (5.4-6.7 kJ/ml) appears particularly useful when nourishing completely with the formula. When the energy density of the liquid formula is 8.4-12.6 kJ/ml, the product may also be useful for intermediate fortification of the patient.

When applying the liquid, solid or semi solid product as an intermediate fortifier (i.e., a “nutritional supplement”) between meals, the product preferably comprises per 100 kilojoule as provided by the product more than 4.0, preferably more than 8, more preferably 20-1000 mg of an added methyl donor, selected from the group of serine, choline, betaine, dimethylglycine, sarcosine, MSM and SAM.

The dry product may be at least partly soluble in water, so as to allow ready make-up of a liquid food, if desired. Preferably at least 50 wt %, more preferably at least 75 wt % of the dry mass is soluble when dissolved as 10% (w/v) in water at 20° Celsius.

The product is relatively energy dense for products for infants. In some embodiments, it provides 600-735 kcal or 2520-3080 and preferably 2800-3040 kJ per 100 grams dry matter. The weight ratio of lipids to protein and digestible carbohydrates is in the range of 2.6-3.8 to 1, preferably 2.7-3.4 and even more preferably 2.7 to about 3 to one.

The amount of digestible carbohydrates is 3.2-9, preferably 4-8.6, more preferably 5-8.2 g per 100 g dry mass. The amount of protein is 13-18, preferably 13.8-17, more preferably 14.2-16.2 g per 100 g dry mass. The amount of lipids is 60-80, preferably 63-75, more preferably 65-72 g per 100 g dry mass.

The protein fraction according to the invention should comprise all essential amino acids, and in particular, relatively high amounts of lysine, leucine and the sulphur amino acids methionine or cysteine, in order to avoid or even counteract growth retardation when providing a ketogenic diet.

Per 100 g protein, the amount of leucine is typically more than 9.4 g and preferably more than 10.2 g. Lysine should preferably be included in an amount of more than 7.7, more preferably more than 7.9 and most preferably more than 9.1 wt. % of the protein.

Of cysteine, suitably more than 1.8, preferably more than 2.2 and even more preferably more 2.4 g is included per 100 g protein in order to facilitate lipid use. The same applies to methionine, i.e. preferably more than 1.8 g, preferably more than 2.2 and even more preferably more than 2.4 g is included per 100 g protein.

The inclusion of alpha-lactalbumin or ingredients which comprise high amounts of protein, are particularly suitable. The presence of more than 20 wt % alpha-lactalbumin in the protein fraction of the product results in easy compliance with the requirements for leucine, lysine, methionine and cysteine, excellent palatability and digestion properties. Preferably more than 20%, more preferably 40-80 wt % of the protein fraction consists of alpha-lactalbumin.

The lipid fraction can comprise triglycerides, diacyl-glycerides, monoacyl-glycerides, phospholipids, lyso-phospholipids, cholesterol and glycolipids. Though excellent products are obtained in terms of efficacy, safety and palatability, by including more than 97% triglycerides as lipid source, the digestibility can be improved by replacing part of the triglycerides by phospholipids, lyso-phospholipids, diacyl-glycerides and/or monoacyl-glycerides. This avoids constipation, and increases the bioavailability of divalent cations, in particular calcium, magnesium and zinc. Replacement of at least 10% and preferably more than 14%, up to e.g. 25% or preferably up to 20% (weight basis) of the triglycerides with one or more of phospholipids, lyso-phospholipids, diacylglycerides and monoglycerides appears to be beneficial in this respect. The amount of phospholipids should be less than 14%, preferably less than 8% of the lipid fraction, in order to prevent too high phosphorous levels, which may impart digestibility of divalent cations.

The lipid fraction may comprise linoleic acid and alpha-linolenic acid. In some embodiments, these together provide more than 15 wt %, in particular more than 17 wt. % of the lipids (on fatty acid basis). Linoleic acid provides more than 14, preferably 15-25, in particular 16-21 energy % of the composition (using also the factor 37.8 kJ/g fatty acid). Alpha-linolenic acid preferably provides at least 1.2 energy % of the composition.

The amount of polyunsaturated fatty acids (i.e. having two or more unsaturated bonds), to which the trans fatty acids have been excluded, is 16-40, preferably 20-30 g per 100 g lipids. It is preferred that the lipid fraction also comprises ω-3 polyunsaturated fatty acids other than alpha linolenic acid. In particular, the polyunsaturated fatty acids comprise more than 0.5, preferably 1.0-10 wt. % of docosahexaenoic acid. It is even more preferred to include in the polyunsaturated fraction arachidonic acid in an amount of more than 1.0 wt. %, up to 6 wt. % of the polyunsaturated fatty acid fraction. The amount of trans fatty acids is below 20, preferably 0-10, more preferably 0.2-4 g per 100 g lipids.

The amount of saturated fatty acids is relatively high. In particular it is preferably between 23 and 50, more preferably 25-45, and even more preferably 33-44 g per 100 g lipids, on fatty acid basis. The saturated fatty acids have 8 to 24 carbon atoms. It is preferred that a major part of the saturated fatty acids is palmitic acid (C16:0). Palmitic acid thus provides e.g. 15-50, preferably 18-45, more preferably 23-44 g per 100 g lipids. A particular embodiment comprises 30-37 g palmitic acid per 100 g lipids. Palm oil is a preferred source for at least 50%, preferably between 70 and 90 of the lipid fraction. The remainder of the lipid fraction can be selected from e.g. safflower, sesame, soybean or sunflower oil or mixtures thereof, preferably soybean oil (preferably between 2 and 30), medium-chain triglycerides (with fatty acids having 8-14 carbon atoms; between 0 and 14), marine oils (preferably between 0 and 14 wt. %, more preferably between 2 and 12 wt. %), and phospholipids, mono- and di-glycerides.

The amount of mono-unsaturated fatty acids is suitably between 25 and 48, preferably 28-43, more preferably 30-40 g per 100 g lipids (fatty acid basis).

A blend of oils as given in Table 1 has been found to be suitable for use in the manufacture of a ketogenic diet.

TABLE 1
Blend of ingredients for use in a ketogenic diet

| | Effective | Preferred | More pref. | Most pref. |
|---|---|---|---|---|
| palm oil(s) | 70–90 | 70–90 RPO | 75–85 PO | 75–85 RPO |
| vegetable oil(s) | 2–30 | 2–30 RSBO | 10–20 VO | 10–20 SBO |
| MCT oil | 0–14 | 0–14 | 0–5 | 1–4 |
| LCPoil (s) | 0–14 | 0–14 | 1–12 of 2 oils | 1–6 AO + |
| | | | | FO |
| PL's | 0–14 | 0–14 | 1–8 lecithins | 3–7 SBL |
| MG or DG | 0–14 | 0–14 | 1–20 DG | 1–20 DG |

Numbers expressed as weight % of the lipid fraction
The various abbreviations will be explained in the text below

Palm oils (PO) are defined to be food grade oils, soluble in diethyl ether, and originating from the palm tree and include crude oils from palm fruits/nuts or palm kernel, which comprise >10% of non-triglycerides compounds (NTG) like carotenoids, terpenes like squalane or squalene, tocopherols and steroids, and refined oils (RPO) from the nuts or kernel or mixtures thereof. NTG is therefore not water or dirt, ash or cell wall material.

Vegetable oils (VO) are defined to be the crude or defined food grade oils originating from soybean, safflower, rapeseed, sunflower or linseed. SBO originates from soybean and may comprises various amounts of non-triglyceride material such as phospholipids. Refined SBO (RSBO) comprises less than 10% non-triglyceride compounds (NTG).

MCT oil are food grade oils known in the art, and defined to comprise more than 90 wt % of the fatty acids being saturated fatty acids having 8, 10 or 12 carbon atoms.

Phospholipids (PL's) can originate from sources known in the art such as egg, soybean or rapeseed and can provide mixtures of phosphatidyl cholines and phosphatidyl ethanolamines and optionally phosphatidyl inositols or phosphatidyl serines.

LCP oil is defined to be any food grade oil that comprises more than 15% of fatty acids having 20 or more carbon atoms. In particular these oils comprise more than 15% docosahexaenoic acid or arachidonic acid. Suitable sources of such oils are marine oils, such as fish oil (FO), algal oils or yeasts, fungi or organisms that are genetically modified to biosynthesize these fatty acids, such as bacteriae, yeasts, plants, or eggs from specifically fed or modified poultry.

The use of these lipids appears to provide a suitable fatty acid profile, low amounts of trans fatty acids, and allows manufacture of products that are well tolerated by epileptic infants or adults.

The digestible carbohydrate fraction can comprise food grade ingredients such as glucose syrup, maltodextrins, lactose, sucrose, galactose, ribose, etc. Though excellent products can be obtained in terms of efficacy when several of the other technical features as disclosed in this description are applied, best results in terms of avoidance of side effects and efficacy are obtained if the digestible carbohydrate fraction takes a specific form. It appears beneficial if at least 20%, preferably 30-90% of the digestible carbohydrate fraction is formed by a source of galactose or ribose. Lactose is considered as suitable ingredient for this purpose. In particular oxidative stress will decrease, when such ketogenic formula is consumed, which comprises such non-glucose digestible carbohydrates.

The digestibility is determined by applying the Englyst 1999 method.

The proteins, lipids, and carbohydrates, preferably originate from at least two different sources, for example, the proteins at least partly from animal, especially milk, source, but optionally also partly from plant source, the lipids at least partly from vegetal source, and the carbohydrates at least partly from milk source, or from a combination of milk (lactose) and plant (glucose, maltodextrins etc.).

The amount of micro ingredients follow recommendations for infants. However, increasing the amounts of several specific ingredients above recommendations improves efficacy and prevents side effects in pediatric epileptics

For example the amount of vitamin B6 should be above 0.8 mg, preferably 0.9-90 mg, most preferably 1.0-60 mg per 100 g dry product, in order to improve efficacy, and decrease negative side effects. This is especially applicable when the product is used in pediatric epileptic patients that do not respond to anti-convulsants. Suitable sources include pyridoxine, pyridoxamine and pyridoxal including phosphates or salts of these components. However, the use of pyridoxal is preferred.

Biotin is another preferred ingredient of the composition of the invention. Infants require 6-200, preferably 8-100, more preferably 9-50 μg per daily dose. Such daily dose is typically provided by 100 g powder, which is reconstituted in water to result in 500 ml food (about 20% solution) for a 2 month old baby. At 6 months of age this daily dose will be increased to 200 g powder. In situations wherein the disorder has a chronic nature and the enteral product is consumed on a daily basis, like many persons suffering from the metabolic syndrome or diabetes type II will do in order to prevent or treat increased plasma ketone levels, the amounts of biotin are preferably 50-1000, more preferably 70-500, even more preferably 80-300 μg per day for children older than 11 years and adults and 10-200, more preferably 15-150, even more preferably 18-100 μg per day. In acute situations like acidosis, the amounts are preferably higher. For example children above 11 years of age and adults will require 300-20000, preferably 360-2000, more preferably 420-1000 μg per daily dose. Infants of younger age need 40-500, preferably 50-250, more preferably 60-150 μg. Premature infants should be administered 9-200, preferably 12-100 and more preferably 15-50 μg per daily dose.

The composition thus preferably contains biotin in an amount of 6-1000 μg, preferably 8-400 μg per 100 g dry matter. For general formulas, the preferred amount is 9-50, in particular 12-50 μg per 100 g. For special purposes, such as acidosis, the preferred amount is 40-400, especially 50-250 μg per 100 g dry matter.

Biotin in the amounts according to the invention is found to decrease the levels of ketone bodies in blood plasma, the levels of AGE products and Maillard products in tissue, and the degree of acidosis in a shorter time, e.g. lactic acidosis but also ketonic acidosis, and to normalize the lipid profile, in particular cholesterol plasma levels.

Vitamin B12 can be provided using suitable sources, such as synthetic Cyanocobalamin, methyl cobalamin, adenosyl cobalamin and hydroxyl cobalamin, for instance obtained from isolates of organs, in particular the liver, e.g. a aqueous concentrate of lysed hepatocytes of agricultural animals, e.g. pig, cow, chicken, with a concentration higher than 75 μg cobalamines per 100 ml extract. The composition preferably contains vitamin B12 in an amount of 0.25-50 μg per 100 g of the dry composition, more preferably 0.4-10 μg and most preferably 0.8-5 μg per 100 g of dry matter.

The amount of pantothenic acid is preferably above 3, more preferably 4-20, most preferably 4.5-14 mg per 100 g dry matter.

Per 100 g dry product more than 25 mg L-camitine and preferably 28-200 mg is included in order to improve energy generation from the product. Very suitable ingredients are the alkylated camitines, especially N-acetyl carnitine or N-propyl or N-isopropyl camitine.

The amount of calcium in the formula is relatively high, i.e. more than 580 and preferably 600-900, more preferably 620-750 mg per 100 g dry mass. In order to allow a high bioavailability of the calcium, the ratio calcium to phosphorous is more than 1.1:1 and more preferably 1.2-2:1. Calcium salts are preferably soluble salts, such as the salts with organic anions.

The amount of taurine is advantageously more than 35, preferably 40-400, more preferably 45-200 mg per 100 g dry product. Suitable taurine sources are known in the art and include taurates.

The product beneficially includes a source of nucleotides, nucleosides or nucleobases. These sources include synthetic compounds such as uridine, cytidine, adenine including their salts, as well as their phosphates, such as uridine monophosphate, uridine diphosphate as well as extracts from yeast, algal-, bacterial- or other cultures or tissue, which provide such components. Very suitable sources include UMP, CMP and cyticoline. Nucleotides or equivalent compounds are preferably included in an amount of 2-600, preferably 6-100, most preferably 10-35 mg per 100 g dry mass. Most preferably uridine is included in an amount of 2-50, preferably 4-30, most preferably 7-12 mg per 100 g dry powder.

The product may also beneficially comprises oligosaccharides, preferably in an amount of 10 mg-2 g, more preferably 40 mg-1.8 g per 100 g dry product. Suitable oligosaccharides include those having a chain length of 3-20 monosaccharide units. Such oligosaccharides preferably comprise at least two but preferably at least three different monosaccharides, of the group galactose, fructose, fucose, mannose, arabinose, glucuronic acid, galacturonic acid, sialic acid, N-acetyl glucosamine. Such mixtures can be obtained by inclusion of pure oligosaccharides or inclusion of at least two mixed oligosaccharides, for example β-galacto-oligosaccharides and fructo-oligosaccharides. Inclusion of such oligosaccharides decreases the immunological problems in patients that use ketogenic diets as single nourishment.

The product has been shown to be effective in improving seizure control, in particular in terms of a lower frequency of seizures in short and long term, and in terms of a decreased severity of seizures. The product is especially effective in infants that have no inborn errors of metabolism, except infants suffering from defects in their glucose transporters, and infants that were irresponsive to anti-convulsant therapy benefit, from the formula. Undesired side effects in terms of growth retardation, metabolic acidosis, decreased immune function, kidney problems and constipation are relatively low.

The product appears also useful when applied in a weight management regimen according to the views of Dr. Atkins for adults having a BMI above 25 and other obese persons and especially in obese persons suffering from the metabolic syndrome or from insulin resistance. This is in particular true when the product is used as single nutrition and preferably when the compositions according the invention are consumed as several ready to use products of which at least two possess a differing physical shape in terms of being liquid, semi-solid or solid.

The product, suitably after reconstitution to a liquid product, can be administered in an amount of between 50 and 200, preferably between 75 and 150 g per day, calculated as dry mass, for infants younger than 12 months, following general energy consumption recommendations, like has been described in the guidelines of the health authorities (e.g. Gezondheidsraad 2000). For older children, the preferred daily amount calculated on dry mass is between 100 and 360, especially between 150 and 300 g. For adults these amounts are 100-500, most preferably 150-340 g for providing most energy as ketone bodies, and at the same time a sufficient amount of essential amino acids, carbohydrate skeletons, and other nutrients and being well tolerated and safe.

### EXAMPLE 1

### Anti-Epileptic Formula for Paediatrics

| | | Per 100 | Per 100 | Per 100 |
|---|---|---|---|---|
| Nutrition Information | | g Powder | kcal* | ml** |
| Energy | kJ | 2918 | 413 | 292 |
| | kcal | 707 | 100 | 70.7 |
| Protein | g | 15.2 | 2.1 | 1.5 |
| Carbohydrate | g | 7.6 | 1.1 | 0.76 |
| as sugars | g | 0.68 | 0.1 | 0.07 |
| Fat | g | 68.4 | 9.7 | 6.8 |
| of which saturates | g | 25.4 | | |
| monounsaturates | g | 23.6 | | |
| polyunsaturates | g | 16.4 | | |
| % LCT | | 100 | | |
| Ratio ω-6: ω-3 fatty acids | | 13.6 | | |
| % energy from linoleic acid | | 19.2 | | |
| % energy from α linolenic acid | | 1.4 | | |
| Fat: protein + carbohydrate (g/g) | | 3:1 | | |
| Fiber | | nil added | | |

| Typical Amino Acid Profile | g/100 g Powder |
|---|---|
| L-Alanine | 0.5 |
| L-Arginine | 0.53 |
| L-Aspartic Acid | 1.1 |
| L-Cystine | 0.42 |
| L-Glutamic Acid | 3.3 |
| Glycine | 0.29 |
| L-Histidine | 0.46 |
| L-Isoleucine | 0.75 |
| L-Leucine | 1.5 |
| L-Lysine | 1.2 |
| L-Methionine | 0.43 |
| L-Phenylalanine | 0.76 |
| L-Proline | 1.6 |
| L-Serine | 0.81 |
| L-Threonine | 0.73 |
| L-Tryptophan | 0.41 |
| L-Tyrosine | 0.81 |
| L-Valine | 0.99 |
| L-Carnitine | 0.03 |
| Taurine | 0.05 |

| Carbohydrate Profile | g/100 g Carbohydrate | g/100 g Powder |
|---|---|---|
| Dextrose | 1.9 | 0.14 |
| Lactose | 0.4 | 0.03 |
| Maltose | 6.7 | 0.51 |
| Maltotriose | 9.5 | 0.72 |
| Higher Saccharides | 81.5 | 6.2 |

| Typical Fatty Acid Profile | g/100 g Fatty Acids |
|---|---|
| C_{16:0} | 34.6 |
| C_{16:1} | 0.2 |
| C_{18:0} | 4.2 |
| C_{18:1} | 35.8 |
| C_{18:2} | 23.1 |
| C_{18:3} | 1.7 |
| C_{20:1} | 0.1 |
| C_{20:2} | 0.3 |

| | | | | Per 100 |
|---|---|---|---|---|
| | | Per 100 g Powder | Per 100 kcal* | ml** |
| Vitamins | | | | |
| Vitamin A | μg RE | 781 | 110 | 78.1 |
| | IU | 2601 | 368 | 260 |
| Vitamin D | μg | 14.1 | 2 | 1.4 |
| | IU | 564 | 79.8 | 56.4 |
| Vitamin E | mg α | 8.9 | 1.3 | 0.89 |
| | T.E. | | | |
| | IU | 13.3 | 1.9 | 1.3 |
| Vitamin C | mg | 134 | 19 | 13.4 |
| Vitamin K | μg | 29.8 | 4.2 | 3 |
| Thiamin | mg | 0.64 | 0.09 | 0.06 |
| Riboflavin | mg | 0.85 | 0.12 | 0.09 |
| Niacin | mg | 8 | 1.1 | 0.8 |
| Niacin equivalent | mg NE | 14.8 | 2.1 | 1.5 |
| Vitamin B₆ | mg | 0.57 | 0.08 | 0.06 |
| Folic Acid | μg | 215 | 30.4 | 21.5 |
| VitaminB₁₂ | μg | 1.3 | 0.18 | 0.13 |
| Biotin | μg | 16.2 | 2.3 | 1.6 |
| Pantothenic Acid | mg | 5.8 | 0.82 | 0.58 |
| Choline | mg | 170 | 24 | 17 |
| Inositol | mg | 170 | 24 | 17 |
| Minerals | | | | |
| Sodium | mg | 318 | 45 | 31.8 |
| | mmol | 13.8 | 2 | 1.4 |
| Potassium | mg | 925 | 131 | 92.5 |
| | mmol | 23.7 | 3.4 | 2.4 |
| Chloride | mg | 547 | 77.4 | 54.7 |
| | mmol | 15.6 | 2.2 | 1.6 |
| Calcium | mg | 649 | 91.8 | 64.9 |
| Phosphorus | mg | 500 | 70.7 | 50 |
| Magnesium | mg | 81.7 | 11.6 | 8.2 |
| Trace Elements | | | | |
| Iron | mg | 10.7 | 1.5 | 1.1 |
| Copper | μg | 710 | 100 | 71 |
| Zinc | mg | 5.7 | 0.81 | 0.57 |
| Manganese | mg | 0.92 | 0.13 | 0.09 |
| Iodine | μg | 127 | 18 | 12.7 |
| Molybdenum | μg | 31.8 | 4.5 | 3.2 |
| Selenium | μg | 19 | 2.7 | 1.9 |
| Chromium | μg | 31.8 | 4.5 | 3.2 |
| Fluoride | mg | 0.85 | 0.12 | 0.09 |

*approximately 14.1 g powder
**10 g made up to 100 mls

This composition is prepared by mixing a blend of palm oils and soybean oils with an aqueous phase comprising the intact milk proteins, maltodextrins, vitamins and minerals and other components like flavors, homogenizing the mixture and spray-drying. Optionally additional heating and cooling steps as well as additional homogenization methods can be included. The product comprises less than 5 wt % trans fatty acids and demonstrates relatively superior resistance against fat oxidation, in terms of formation of oxidation components and off flavors.

### EXAMPLE 2

### New Formula for Paediatric Infants

Product as in example 1, however modified for specific components:

| Component | per 100 g powder |
|---|---|
| Vitamin B6 | 0.9 mg |
| Carnitine | 50 mg |
| | (as acetyl-L-carnitine) |
| Taurine | 60 mg |
| Pantothenic acid | 4 mg |

We claim:

1. A solid or semi-solid nutritional composition comprising a protein fraction, a lipid fraction and a digestible carbohydrate fraction, which composition provides 2520-3080 kJ per 100 g dry mass of energy, and wherein the fractions are obtained from at least two different sources, and the ratio of the lipid fraction to the sum of the protein and digestible carbohydrate fractions together is 2.6-3.8 to 1 by weight.

2. The nutritional composition of claim 1, in which the ratio of the lipid fraction to the sum of protein and digestible carbohydrate fractions together is 2.7-3.4 to 1.

3. The nutritional composition of claim 1, in which the lipid fraction comprises 23-50 wt. % of palmitic acid, on fatty acid basis.

4. The nutritional composition of claim 1, in which the lipid fraction comprises 10-25 wt. % of one or more of phospholipids, lyso-phospholipids, diacylglycerides and monoglycerides.

5. The nutritional composition of claim 1, in which the lipid fraction comprises 16-40 wt. % of polyunsaturated fatty acids, on fatty acid basis.

6. The nutritional composition of claim 5, in which the polyunsaturated fatty acids comprise 1-10 wt % of docosahexaenoic acid.

7. The nutritional composition of claim 1, in which the protein fraction comprises at least 20 wt. % of α-lactalbumin.

8. The nutritional composition of claim 1, in which the carbohydrate fraction comprises 20-90 wt. % of galactose and/or ribose units.

9. The nutritional composition of claim 1, further comprising 6-100 mg of nucleotides per 100 g of dry matter.

10. The nutritional composition of claim 1, further comprising 40 mg-1.8 g per 100 g of dry matter of one or more non-digestible oligosaccharides having 3-20 monosaccharide units, the non-digestible oligosaccharides further comprising at least two different monosaccharide units selected from the group consisting of galactose, fructose, fucose, mannose, arabinose, glucuronic acid, galacturonic acid, sialic acid, and N-acetyl glucosamine.

11. The nutritional composition according to claim 1 wherein at least 50% of the dry mass is soluble when dissolved as 10% (w/v) in water at 20° C.

12. The nutritional composition according to claim 3 wherein at least 50% of the dry mass is soluble when dissolved as 10% (w/v) in water at 20° C.

13. The nutritional composition according to claim 4 wherein at least 50% of the dry mass is soluble when dissolved as 10% (w/v) in water at 20° C.

14. The nutritional composition according to claim 7 wherein at least 50% of the dry mass is soluble when dissolved as 10% (w/v) in water at 20° C.

15. The nutritional composition according to claim 8 wherein at least 50% of the dry mass is soluble when dissolved as 10% (w/v) in water at 20° C.

16. The nutritional composition according to claim 9 wherein at least 50% of the dry mass is soluble when dissolved as 10% (w/v) in water at 20° C.

17. The nutritional composition according to claim 10 wherein at least 50% of the dry mass is soluble when dissolved as 10% (w/v) in water at 20° C.

18. A liquid nutritional product comprising, water, a protein fraction, a lipid fraction and a digestible carbohydrate fraction, which composition provides 2520-3080 kilojoule per 100 g dry mass of energy, wherein the fractions are obtained from at least two different sources, and wherein the ratio of lipid fraction to the sum of the protein and digestible carbohydrate fractions together is 2.6-3.8 to 1 by weight.

19. The liquid product of claim 12 further comprising vitamins, trace elements, or both.

20. The liquid product of claim 12 having an energy density of 1.2-1.8 kcal/ml.
